(19) United States
(12) Patent Application Publication
(10) Pub. No.: US 2016/0371996 A1
(43) Pub. Date: Dec. 22, 2016

(54) SYSTEMS AND METHODS FOR A DIGITAL FLOW CHART PREDICTING DENTAL RECOMMENDATIONS

(71) Applicant: George Allen Carr, JR., Scottsdale, AZ (US)

(72) Inventor: George Allen Carr, JR., Scottsdale, AZ (US)

(21) Appl. No.: 14/744,283

(22) Filed: Jun. 19, 2015

(51) Int. Cl. G09B 7/02; G09B 23/28

(52) U.S. Cl. CPC G09B 7/02; G09B 23/283

(57) ABSTRACT

A system for predicting recommended dental treatment comprises, a plurality of questions; questions having distinct answers; each answer leading to another question or statement; and each statement would be a common dentist recommendation. A method for predicting dental recommendations for a dental concern using a system comprising one or more questions, comprises generating a plurality of answers; answering questions in a specific order; and receiving dental information related to the results of the specific questions and answers. A system for estimating needed dental treatment comprises a plurality of questions; questions having distinct answers; each answer leading to another question or statement; and each statement would be a dental diagnosis. A system for referring an individual to a dentist comprises a plurality of questions; questions having only distinct answers; a statement of probable dental diagnosis; an individual given information for a specific demographic dentist and Referral to a dentist who prefers doing that specific type of dentistry.

### CROSS-REFERENCE TO RELATED APPLICATIONS

This application claims priority to U.S. Provisional Patent Application No. 62014270, entitled “How Chart Conveying Dental Recommendations,” filed on Jun. 19, 2014, which is hereby incorporated by reference for all purposes.

### BACKGROUND

Many times when people have a dental concern, they do not understand what needs to be done to resolve the concern. Some ask their friends for second-hand advice. Some go online to be bombarded with too much collect and incorrect information. Some attempt to see a dentist. For whatever reason, many people will not or cannot see a dentist quickly. If people were given more accurate and timely information regarding dental problems, visits to a dental office may be sooner, less expensive, and in higher frequency. Over time, society's oral health would improve. But before a society's oral health improves, individuals must be dentally informed.

### OBJECTIVE

An objective for the patent is to help an individual anticipate what a dentist would recommend for the individual's dental concern. The information would be obtained by the individual answering a plurality of questions. The questions would be asked in a predetermined, specific order. Each question would give possible answers. Each answer either leads to another question, or a statement. Each statement could be a common dentist recommendation. An option for an explanation of each statement may be given. An explanation may include the dental diagnosis implied from the prior questions and answers, and the logic behind it. This probable dental diagnosis may facilitate a better understanding of the dental situation, the options for care, and the recommended treatment. Additionally, the individual could have all the questions, answers, and explanation communicated to them or whomever. For example, it may be emailed. There would also be an option to request a dentist referral, dentist recommendation, or inform a dentist as well. The aforementioned could be performed through software, a website, or conventional applications running on iOS, Android, Windows, etc. Currently, a working example of the above is displayed on http://www.miniDENTIST.com, and it was working prior to June 18, 2014, and became public after June 20, 2014.

### DRAWING DESCRIPTIONS

FIG. 1 depicts the master outline of how the questions and statements will be asked or stated. Each number in FIG. 1 is associated with a question or statement in FIG. 2. Each line \566 from left to downward right means Y or Yes to the question preceding it. Each line/577 from right to downward left means N or No to the question preceding it. Each ▴ 555 represents additional aspects of the flow chart conveyed in FIG. 2.

FIG. 2 has three columns. Column A has numbers which may correlate in FIG. 1. Column B conveys how specific questions or statements are arranged with the other questions or statements. Column C has the questions or statements. For example, question 1 has a Column B of S10. If the answer to question 1 was Yes, Column B would convey what the next question or statement would be by adding a Y to S10. This would make the next question or statement's Column B be S10Y, and so on.

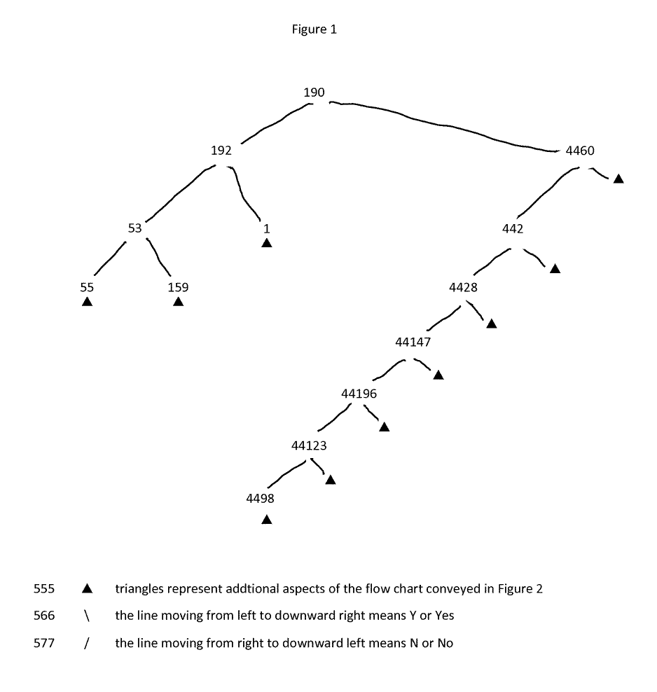

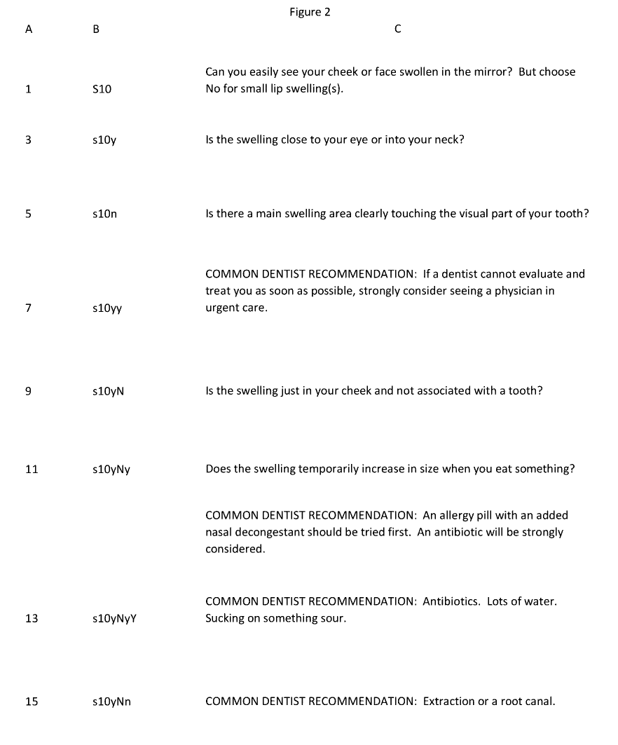

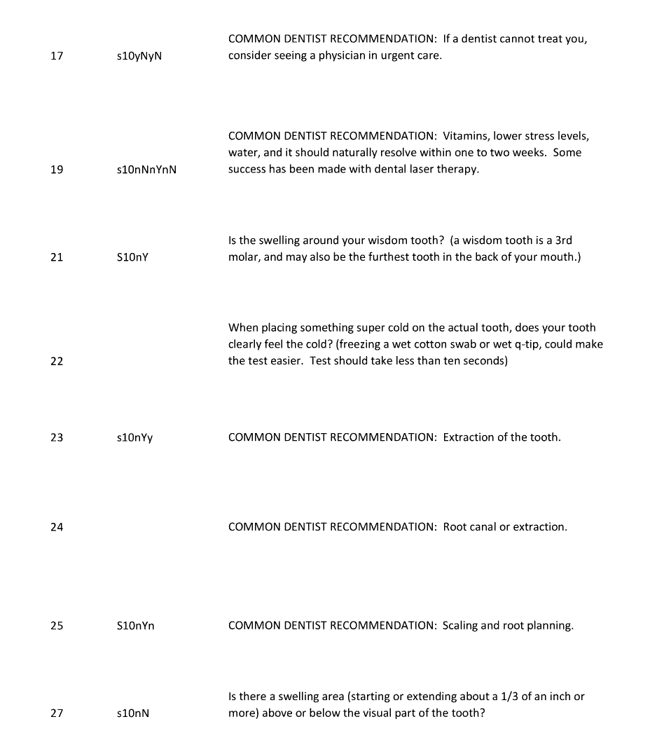

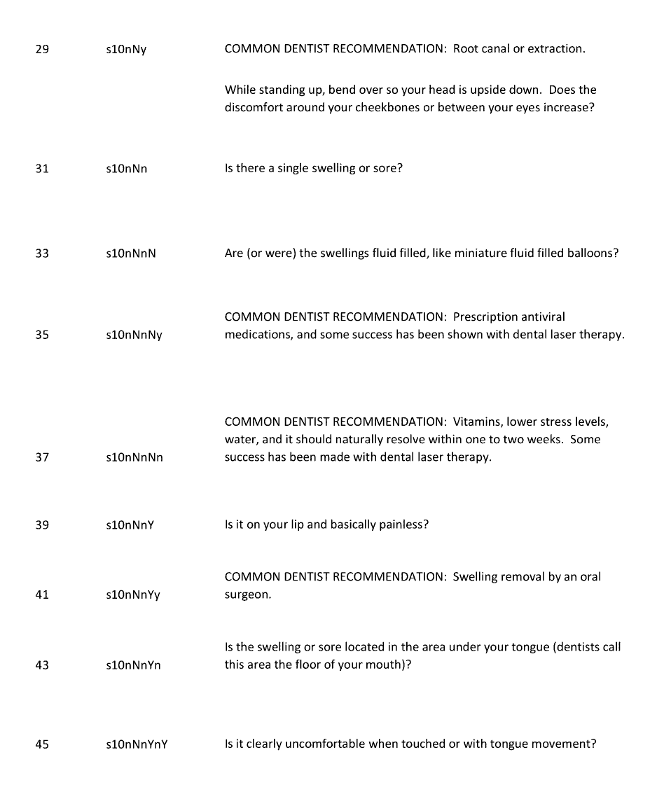

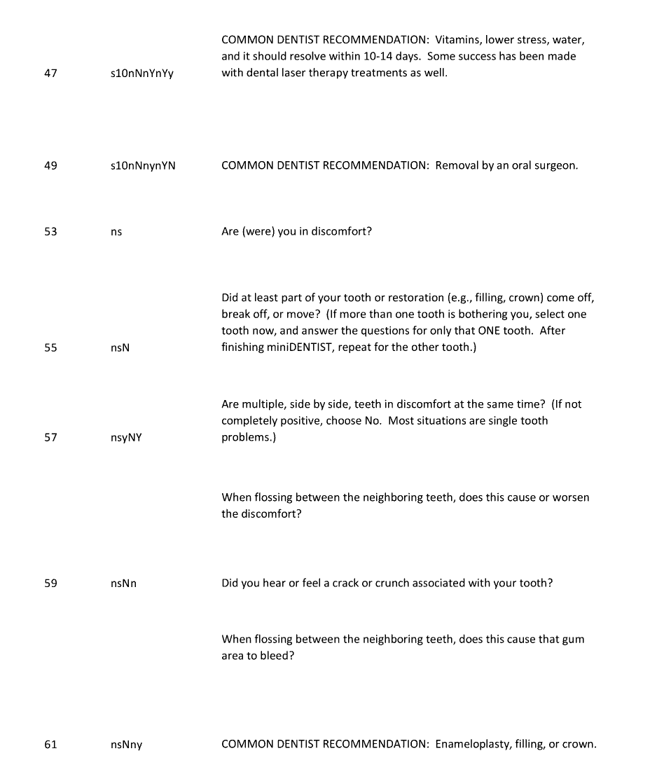

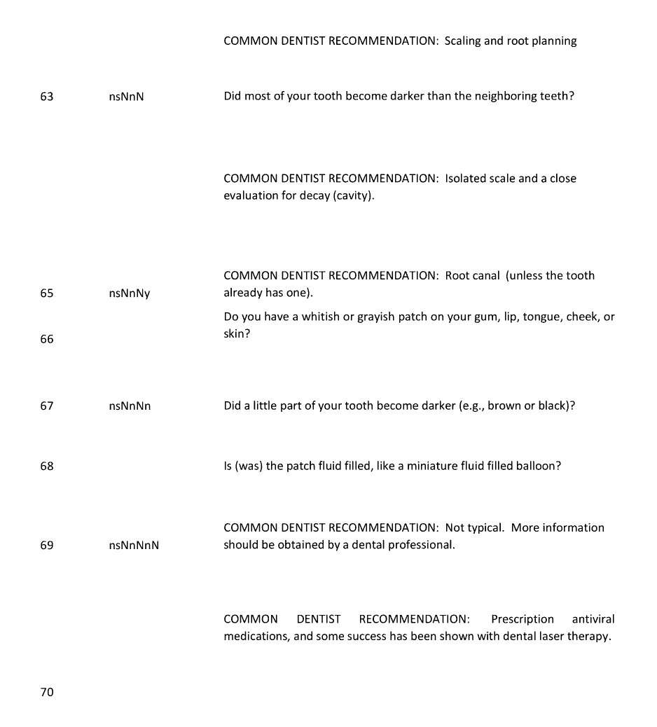

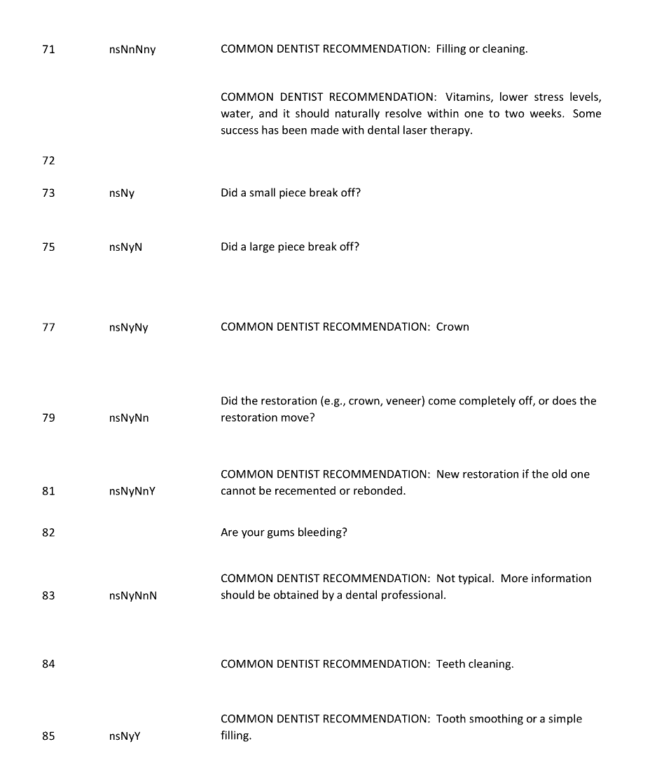

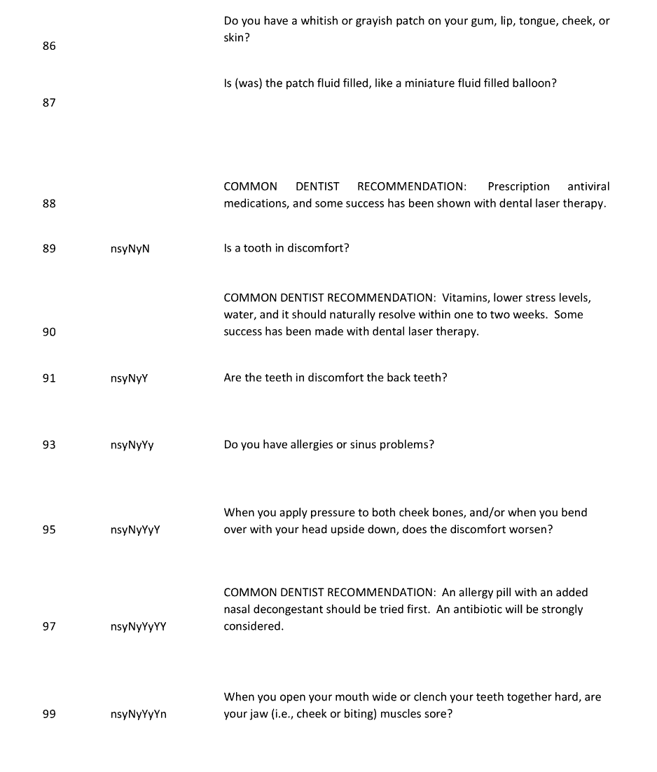

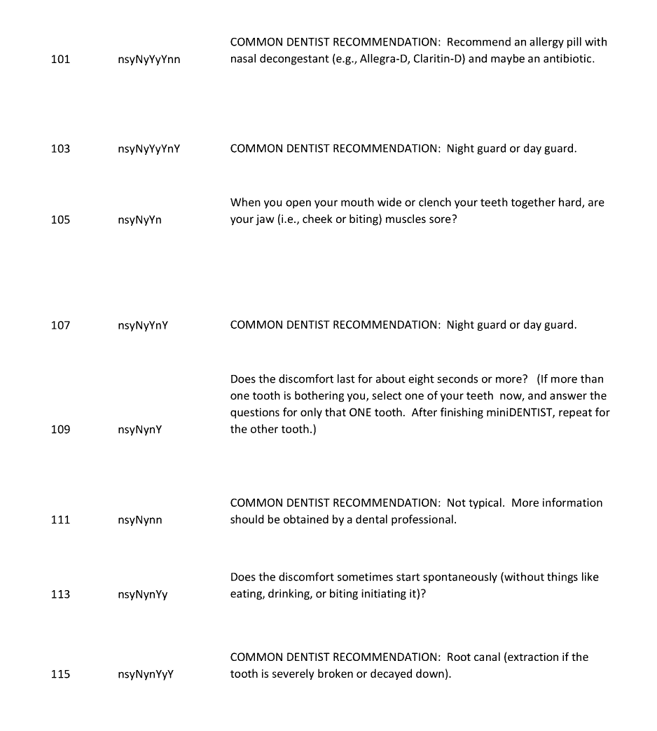

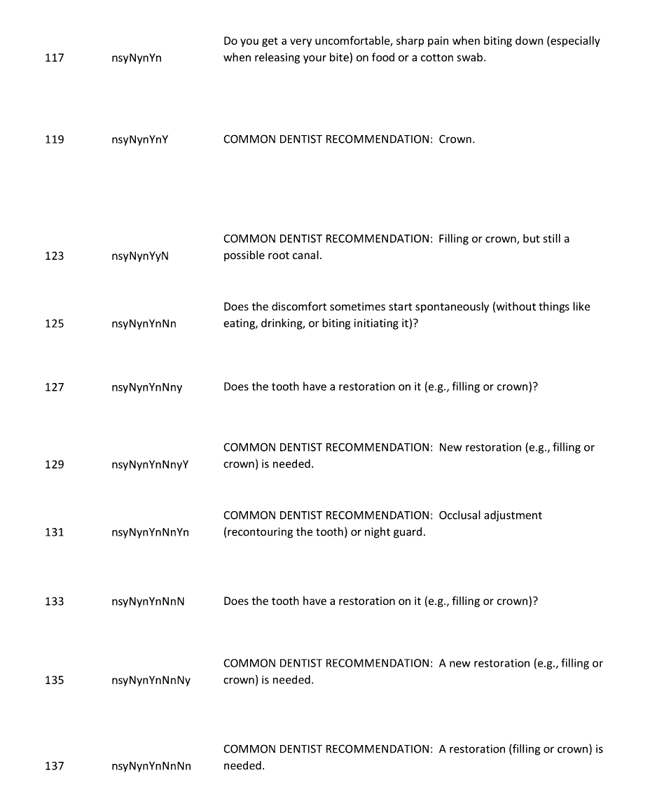

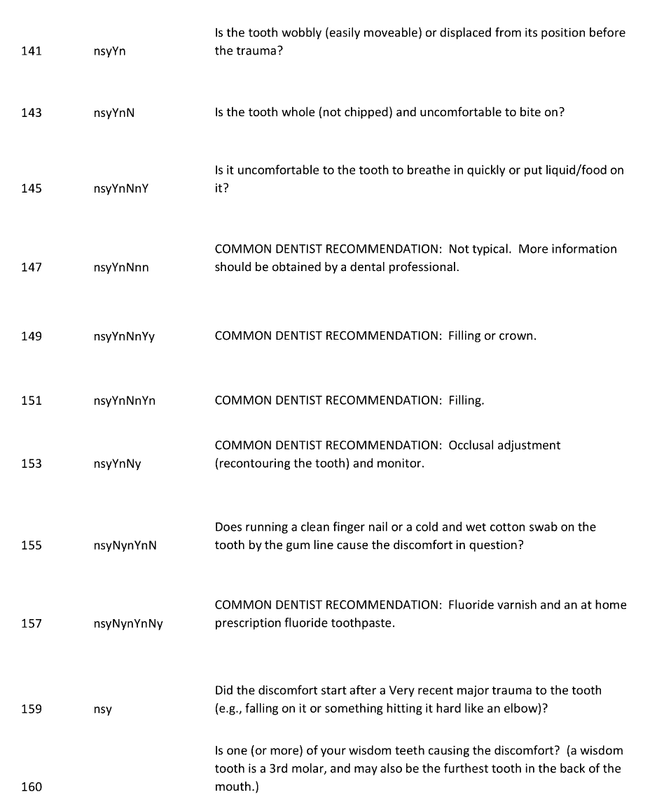

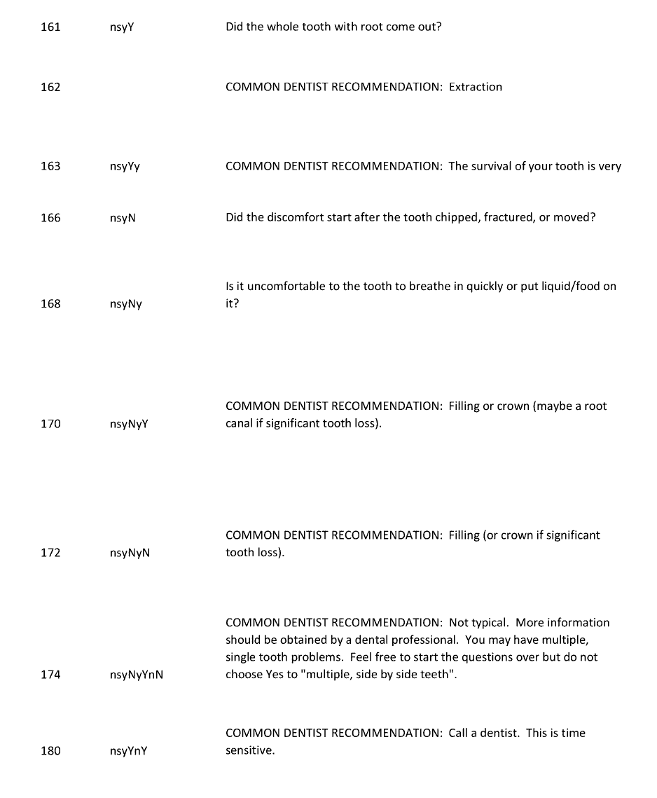

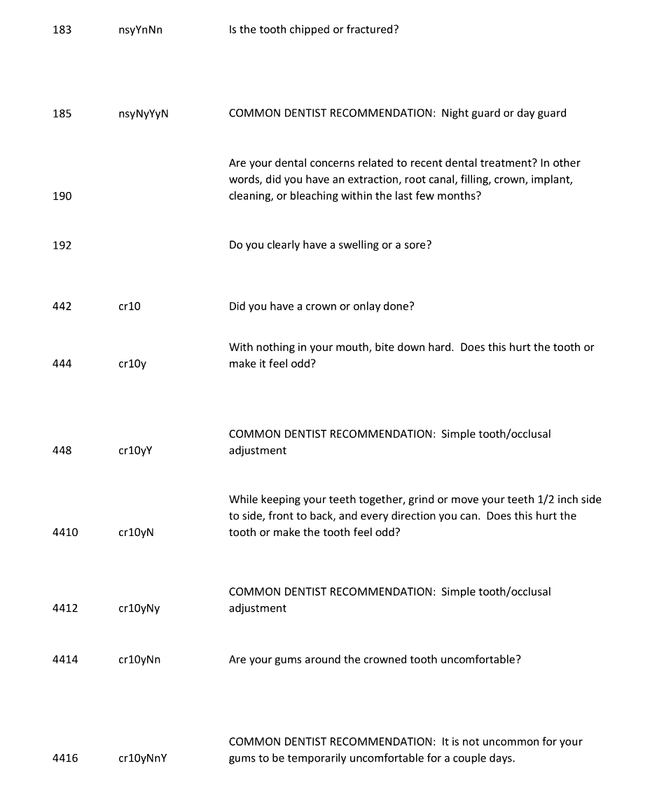

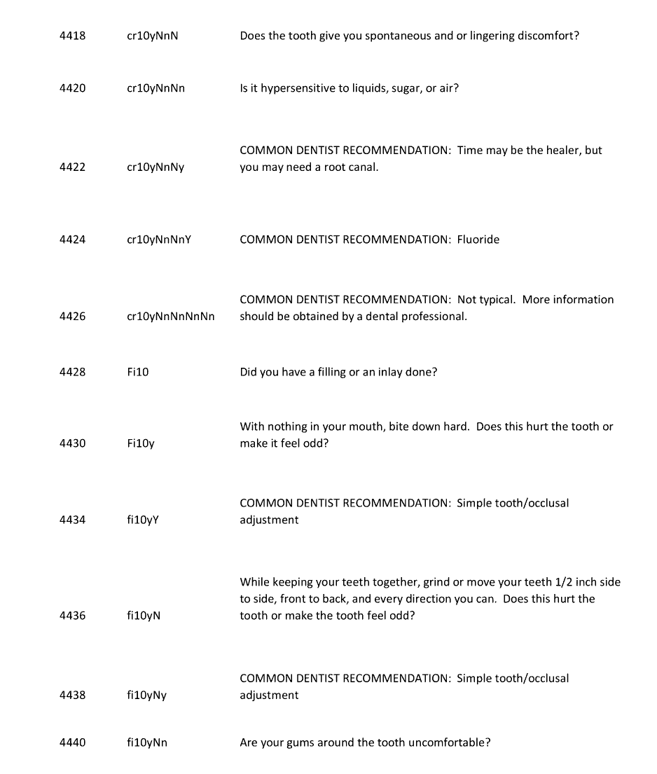

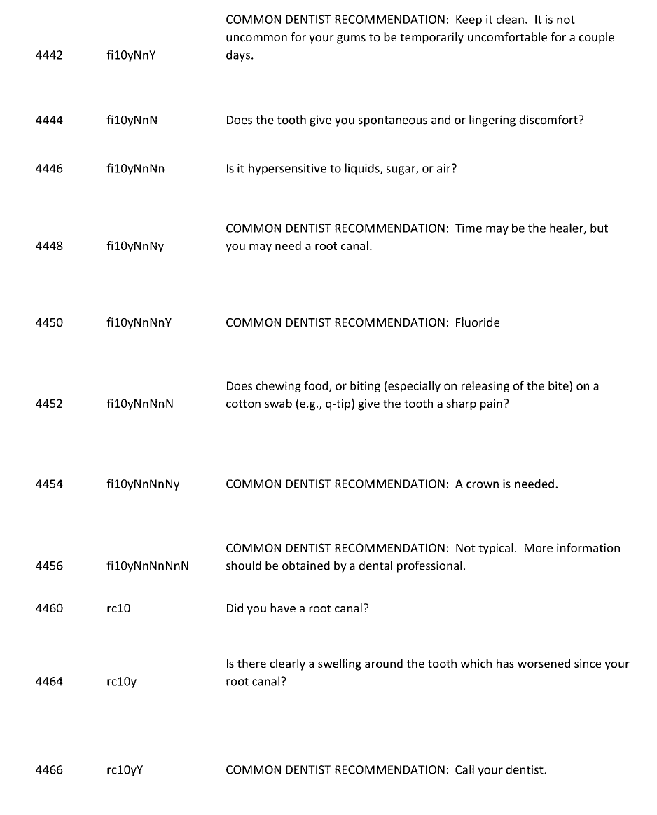

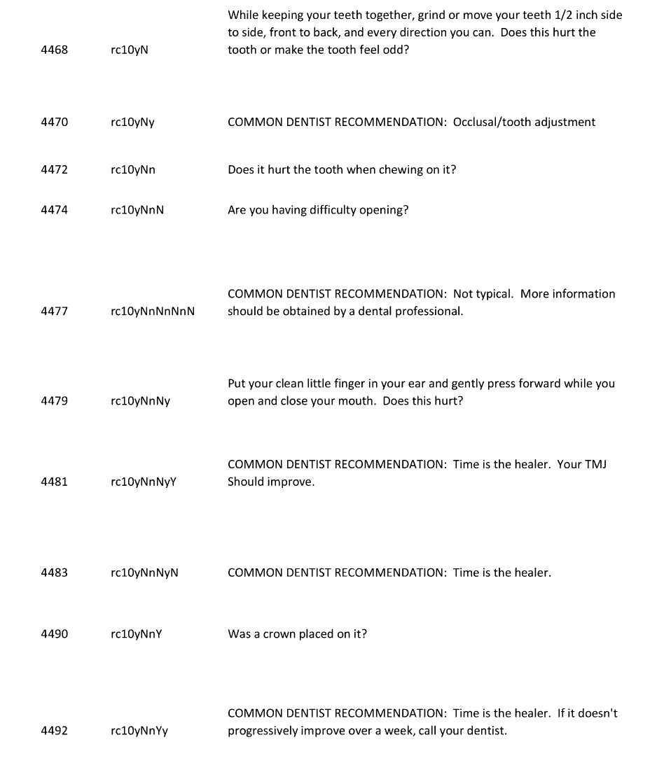

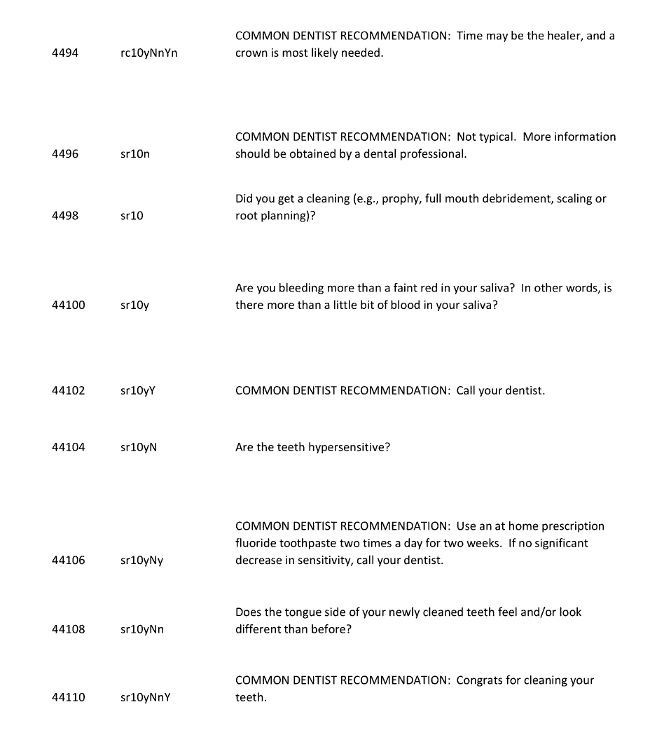

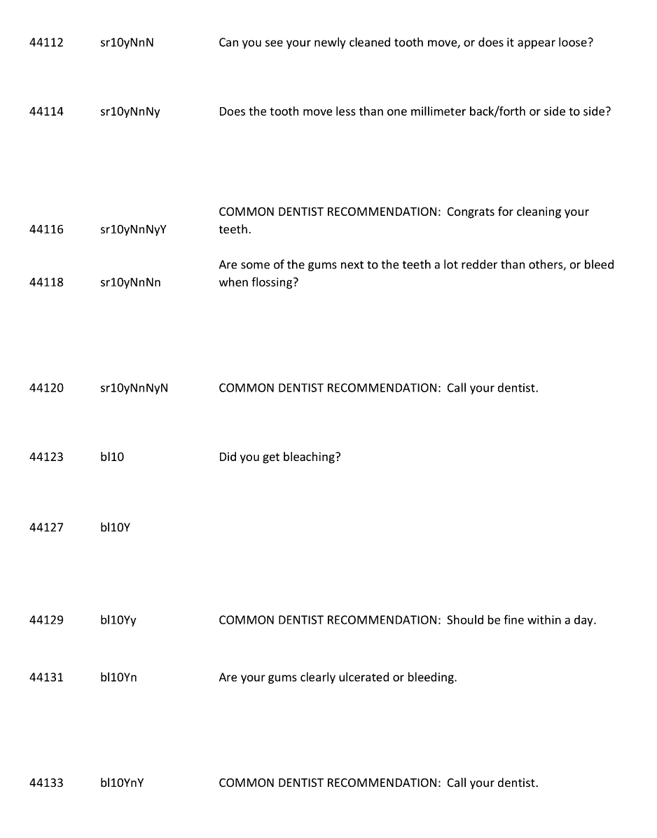

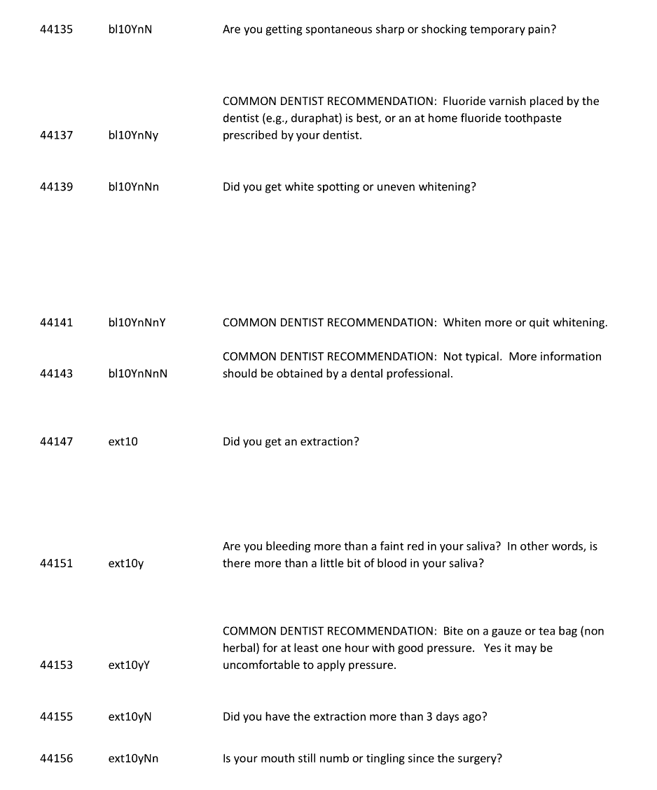

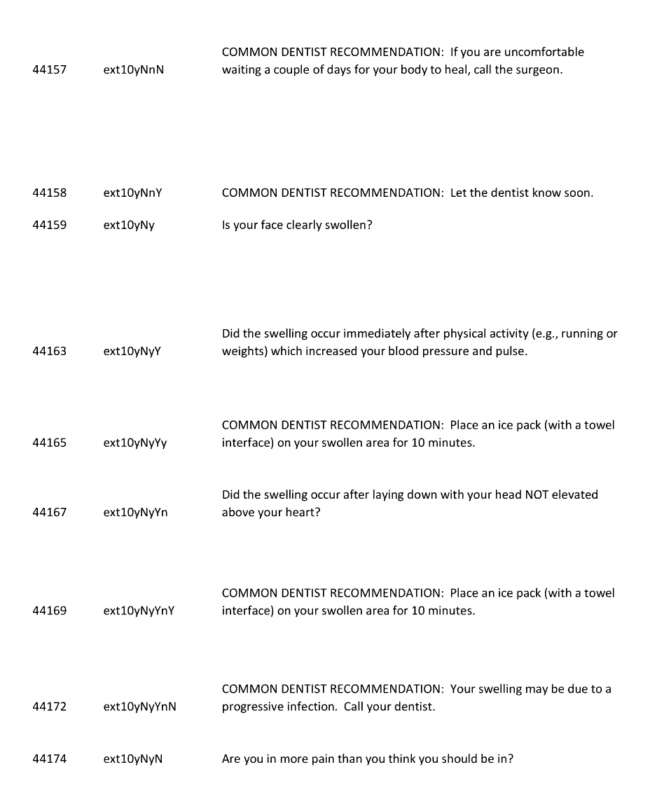

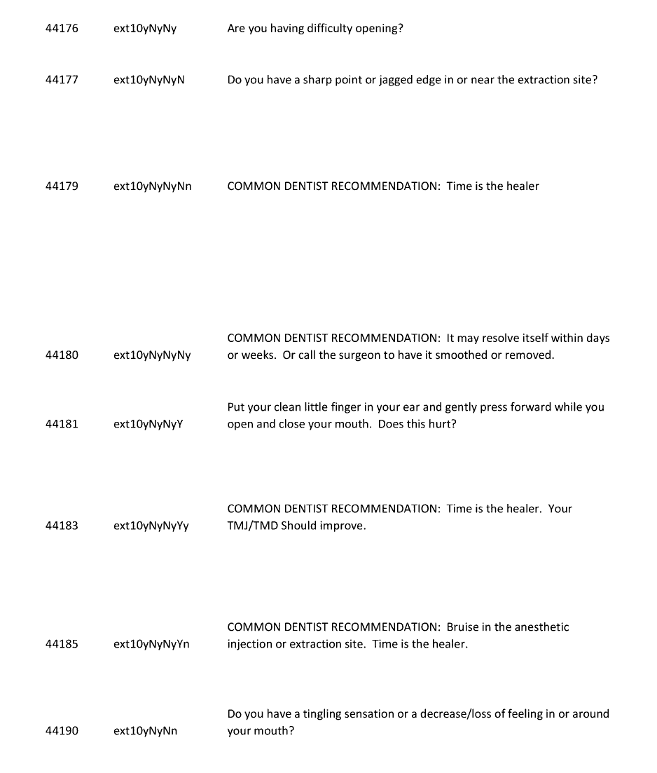

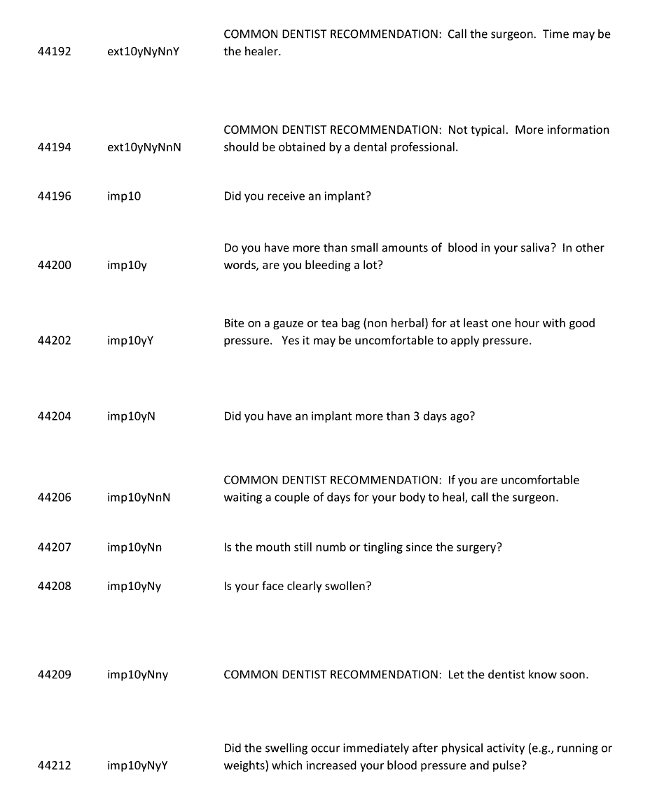

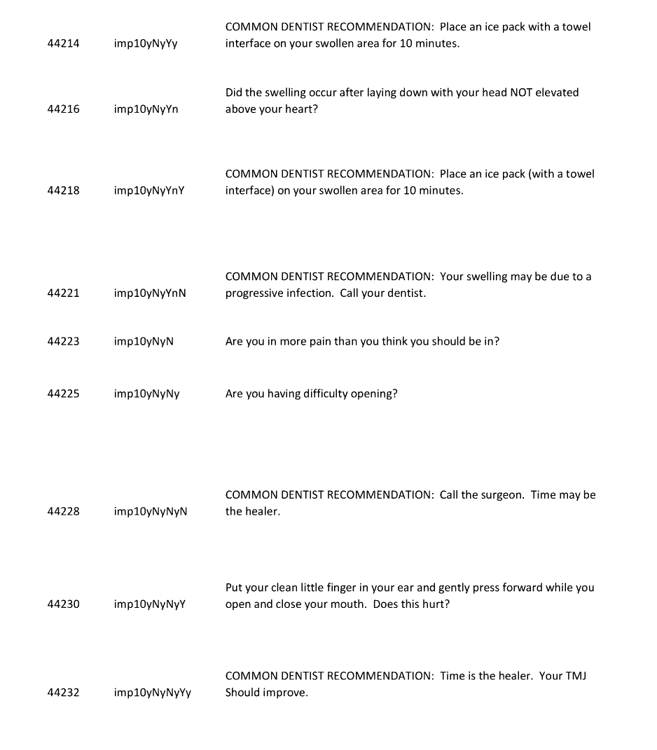

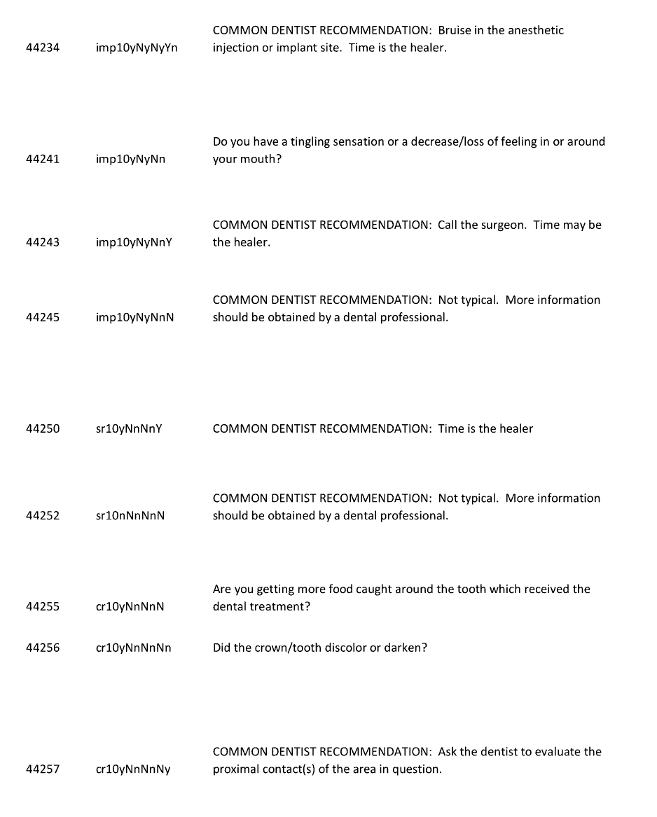

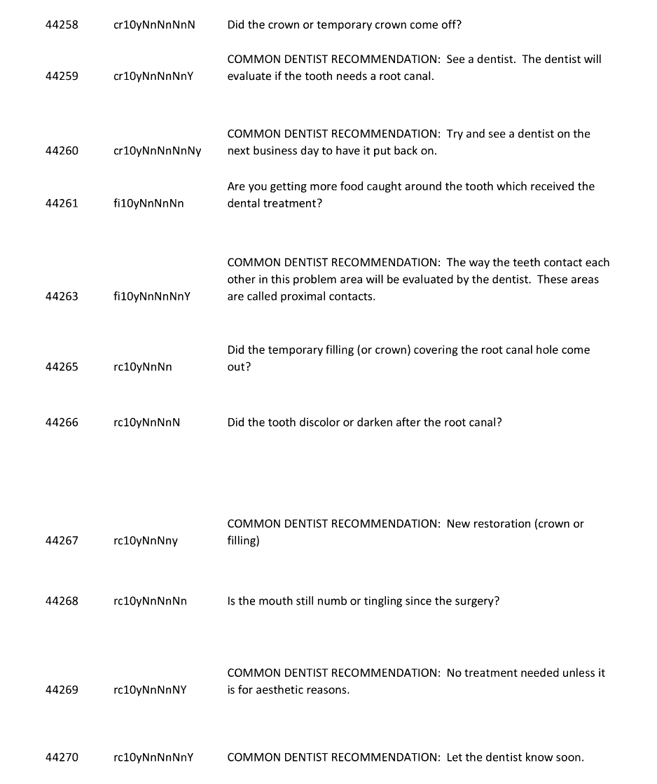

That is claimed is:

1. A system for predicting needed dental treatment, the system comprising:
A plurality of questions;
questions having distinct answers;
each answer leading to another question or statement; and
each statement would be a common dentist recommendation.

2. A system as set forth in claim 1, wherein the answer to the question is one of three answers.

3. A system as set forth in claim 1, wherein the answer to the question is one of two answers.

4. A system as set forth in claim 1, wherein the answer to the question has an explanation.

5. A system as set forth in claim 1, wherein the answer can be digitally transferred.

6. A system as set forth in claim 1, wherein a dentist may be informed.

7. A system as set forth in claim 1, wherein there is only one initial question which may lead to all statements.

8. A system as set, forth in claim 7, wherein the question is asking if the dental concern is related to recent dental treatment received.

9. A system as set forth in claim 7, wherein the question is asking if the dental concern is uncomfortable.

10. A system as set forth in claim 7, wherein the question is asking if the dental concern is swelling.

11. A system as set forth in claim 1, wherein one question asks if the concern is related to recent dental treatment received. A possible following question asks if the dental concern is related to swelling. Then, possible next question asks if the dental concern is related to discomfort.

12. A method for predicting dental information for a dental concern using a system composing one or more questions, the method comprising:
generating a plurality of answers;
answering questions in a specific order; and
receiving dental information related to the results of the specific questions and answers.

13. A method as set forth in claim 12, wherein there is only one initial question which may lead to all statements.

14. A method as set forth in claim 13, wherein the question is asking if the dental concern is related to recent dental treatment received.

15. A method as set forth in claim 13, wherein the question is asking if the dental concern is uncomfortable.

16. A method as set forth in claim 13, wherein the question is asking if the dental concern is swelling.

17. A method as set forth in claim 12, wherein one question asks if the concern is related to recent dental treatment received. A possible following question asks if the dental concern is related to swelling. Then, possible next question asks if the dental concern is related to discomfort.

18. A method as set forth in claim 13, wherein one question asks an age related question.

19. A system for estimating needed dental treatment, the system comprising:
A plurality of questions;
questions having distinct answers;
each answer leading to another question or statement; and
each statement would be a dental diagnosis.

20. A system as set forth in claim 19, wherein the answer to the question is one of three answers.

21. A system as set forth in claim 19, wherein the answer to the question is one of two answers.

22. A system as set forth in claim 19, wherein the answer to the question has an explanation.

23. A system as set forth in claim 19, wherein the answer can be digitally transferred.

24. A system as set forth in claim 19, wherein a dentist referral may be requested.

25. A system as set forth in claim 19, wherein there is only one initial question which may lead to all statements.

26. A system as set forth in claim 25, wherein the question is asking if the dental concern is related to recent dental treatment received.

27. A system as set forth in claim 25, wherein the question is asking if the dental concern is uncomfortable.

28. A system as set forth in claim 25, wherein the question is asking if the dental concern is swelling.

29. A system as set forth in claim 19, wherein one question asks if the concern is related to recent dental treatment received. A possible following question asks if the dental concern is related to swelling. Then, possible next question asks if the dental concern is related to discomfort. 30, A system for referring an individual to a dentist, the system comprising:
a plurality of questions;
questions having only distinct answers;
a statement of probable dental diagnosis;
an individual given information for a specific demographic dentist; and
referral to a dentist who prefers doing that specific type of dentistry.
